(19) United States
(12) Patent Application Publication
(10) Pub. No.: US 2023/0003851 A1
(43) Pub. Date: Jan. 5, 2023

(54) MEASUREMENT APPARATUS

(71) Applicant: DENSO CORPORATION, Kariya-city (JP)

(72) Inventor: Hideaki TANAKA, Kariya-city (JP)

(21) Appl. No.: 17/930,356

(22) Filed: Sep. 7, 2022

Related U.S. Application Data
(63) Continuation of application No. PCT/JP2021/008134, filed on Mar. 3, 2021.

(30) Foreign Application Priority Data
Mar. 11, 2020 (JP) 2020-042050

(51) Int. Cl. G01S 7/486; G01S 17/931; G01S 17/10; G01S 7/497; G01S 7/4865

(52) U.S. Cl. CPC G01S 7/4868; G01S 17/931; G01S 17/10; G01S 7/497; G01S 7/4865

(57) ABSTRACT

A measurement apparatus mounted to a vehicle includes a light emitting unit, at least one light receiving element, a measurement unit, a monitor circuit, and an adjustment unit. An adjustment unit adjusts the sensitivity of the at least one light receiving element, based on a monitor signal generated by the monitor circuit based on a light reception signal from the at least one light receiving element having received reference light.

### CROSS-REFERENCE TO RELATED APPLICATION

The present application is a continuation application of International Application No. PCT/JP2021/008134, filed on Mar. 3, 2021, which claims priority to Japanese Patent Application No. 2020-42050, filed on Mar. 11, 2020. The contents of these applications are incorporated herein by reference in their entirety.

### BACKGROUND

### Technical Field

The present disclosure relates to a measurement apparatus that measures an object by irradiating the object with pulsed light.

### Background Art

A measurement apparatus is known that measures a distance to an object, or the like by irradiating the object with pulsed light and receiving reflected light of the pulsed light with a light receiving element such as an APD. In such a measurement apparatus, a multiplication factor of the light receiving element needs to be suitably adjusted.

### SUMMARY

In the present disclosure, provided is a measurement apparatus mounted to a vehicle as the following.

The measurement apparatus includes a light emitting unit, at least one light receiving element, a measurement unit, a monitor circuit, and an adjustment unit. An adjustment unit adjusts the sensitivity of the at least one light receiving element, based on a monitor signal generated by the monitor circuit based on a light reception signal from the at least one light receiving element having received reference light.

### BRIEF DESCRIPTION OF THE DRAWINGS

FIG. 1 is a block diagram of a measurement apparatus.

FIG. 2 is a block diagram of a light receiving element and the like in the measurement apparatus and an adjustment apparatus.

FIG. 3 is a flowchart of an adjustment process.

FIG. 4 is a flowchart of voltage search processing.

### DETAILED DESCRIPTION OF THE PREFERRED EMBODIMENTS

In an adjustment method for a light receiving element such as an APD disclosed in PTL 1, the light receiving element is irradiated with reference light from a reference light source. Then, a bias voltage of the light receiving element is varied, while a signal output from the light receiving element having received the reference light is being monitored. Thus, the bias voltage is searched for that corresponds to a multiplication factor of a target value.
[PTL 1] JP-54468 A

### SUMMARY OF THE INVENTION

However, as a result of detailed studies, the inventors have found a problem with the technique disclosed in PTL 1 in that the technique may require a complicated configuration for adjustment of the multiplication factor. Specifically, as the reference light used to adjust the multiplication factor, pulsed light is assumed to be used as is the case with measurement of the distance to an object. In such a case, a signal from the light receiving element needs to be monitored during an ON period of the pulsed light. However, the ON period of the pulsed light, which is short, may complicate a configuration required to synchronize a monitoring timing for the signal from the light receiving element with the ON period of the pulsed light.

An aspect of the present disclosure provides a measurement apparatus that can more simply adjust the light receiving element.

A measurement apparatus of a mode of the present disclosure is mounted to a vehicle and includes a light emitting unit, at least one light receiving element, a measurement unit, a monitor circuit, and an adjustment unit. The light emitting unit radiates pulsed light. The at least one light receiving element is an element that outputs a light reception signal corresponding to an amount of light received at a preset sensitivity, and is configured to receive reflected light of the pulsed light radiated by the light emitting unit. The measurement unit is configured to measure an object based on the light reception signal output from the at least one light receiving element having received the reflected light. The monitor circuit is configured to generate a monitor signal indicating the amount of light received by the at least one light receiving element based on the light reception signal output from the at least one light receiving element. The adjustment unit is configured to adjust the sensitivity of the at least one light receiving element, based on the monitor signal generated by the monitor circuit based on the light reception signal from the at least one light receiving element having received reference light with an intensity fixed to a present level.

According to the above-described configuration, when the sensitivity of the light receiving element is adjusted, the light receiving element is irradiated with the reference light with an intensity fixed to the preset level. Thus, a timing when the light receiving element is irradiated with the reference light can be easily synchronized with a timing when the monitor signal is monitored. Consequently, the light receiving element can be more simply adjusted.

Embodiments of the present disclosure will be described below with reference to the drawings.

### 1. Configuration

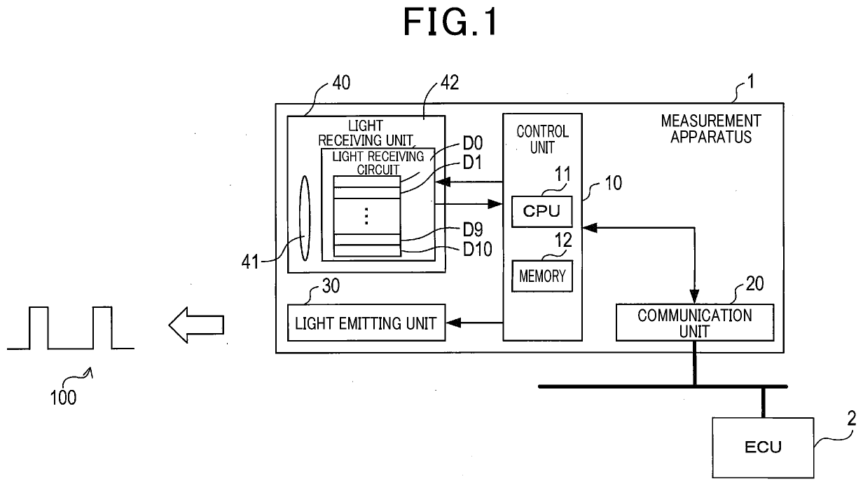

A measurement apparatus 1 of the present embodiment connected to an in-vehicle network, for example, CAN (registered trademark) or the like is mounted in a vehicle (hereinafter referred to as an own vehicle) (see FIG. 1). The measurement apparatus 1 emits pulsed laser light (hereinafter referred to as pulsed light 100). Then, based on the elapsed time after the emission of the pulsed light 100 and before reception of reflected light of the pulsed light 100, the measurement apparatus 1 measures the distance between the own vehicle and a reflection point where the pulsed light 100 is reflected. Thus, the distance between the own vehicle and the object present in front of the own vehicle is measured. Note that the present embodiment is not limited to the above-described configuration and that based on the reception of the reflected light, the measurement apparatus 1 may, for example, measure the speed of an object or the presence of an object in front of the own vehicle.

The measurement apparatus 1 includes a control unit 10, a communication unit 20, a light emitting unit 30, and a light receiving unit 40. The units of the measurement apparatus 1 will be described below.

### 2. Control Unit, Communication Unit, and Light Emitting Unit

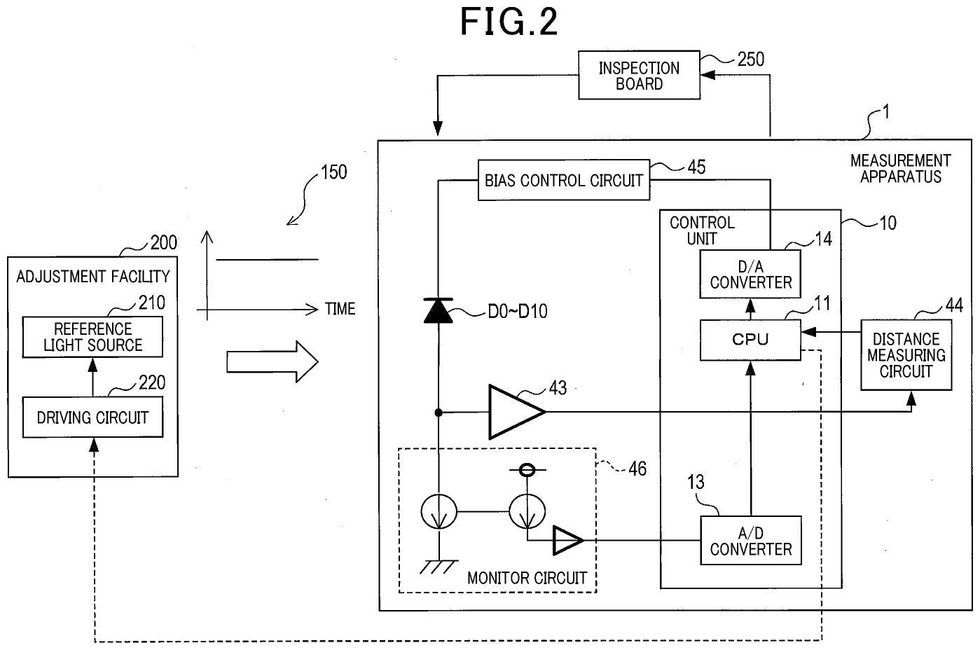

The control unit 10 is a unit that controls the measurement apparatus 1 in an integrated manner, and includes a microcomputer including a CPU 11 and a semiconductor memory such as a RAM, a ROM, or a flash memory (hereinafter referred to as a memory 12). Additionally, the control unit 10 includes an A/D converter 13 and a D/A converter 14 (see FIG. 2).

The CPU 11 executes a program stored in the memory 12. The CPU 11 executes the program stored in a non-transitory tangible storage medium to implement the functions of the measurement apparatus 1. In the present embodiment, the memory 12 corresponds to the non-transitory tangible storage medium storing the program. Additionally, by executing the program, a method corresponding to the program is executed. Note that the measurement apparatus 1 may include one microcomputer or a plurality of microcomputers. In addition, an approach implementing the functions of the measurement apparatus 1 is not limited to software, and some or all of the functions may be implemented using an electronic circuit. In this case, the electronic circuit may be configured as a digital circuit or an analog circuit or a combination of digital and analog circuits.

The A/D converter 13 performs A/D conversion on the monitor signal received from a monitor circuit 46 described below, and outputs a conversion result to the CPU 11.

The D/A converter 14 performs D/A conversion on the value of a bias voltage set by the CPU 11 to generate a bias voltage signal corresponding to an analog signal indicating the value. Then, the D/A converter 14 outputs the bias voltage signal to a bias control circuit 45. Note that the bias voltage signal and the bias control circuit 45 will be described later.

The communication unit 20 is connected to the in-vehicle network to communicate with an ECU 2. A measurement result for the distance measured by the measurement apparatus 1 is transmitted via the in-vehicle network to the ECU 2, which performs, for example, driving assistance or automatic driving.

In response to an indication from the control unit 10, the light emitting unit 30 radiates the pulsed light 100 to the front of the own vehicle.

### 3. Light Receiving Unit

The light receiving unit 40 includes an optical system 41, a light receiving circuit 42 including a plurality of light receiving elements D0 to D10, a plurality of amplification circuits 43 provided corresponding to the light receiving elements, a distance measuring circuit 44, the bias control circuit 45, and a monitor circuit 46 (see FIGS. 1 and 2).

The optical system 41 includes a condensing lens and an optical path changing unit that are not illustrated, and receives reflected light via the condensing lens. Then, in response to an indication from the control unit 10, the optical system 41 rotationally displaces the optical path changing unit with a mirror and the like, and irradiates any of the light receiving elements D0 to D10 with reflected light received.

The light receiving circuit 42 includes the plurality of (in the present embodiment, 11 by way of example) light receiving elements D0 to D10. Of course, the number of light emitting elements is not limited to 11, but for example, the light receiving circuit 42 may be provided with one or a plurality of light receiving elements. Additionally, in the present embodiment, by way of example, the light receiving element is configured as an avalanche photo diode (hereinafter referred to as an APD).

The plurality of light receiving elements D0 to D10 are arranged in a line along a vehicle width direction (in other words, a horizontal direction), and each of the light receiving elements D0 to D10 is associated with one of eleven orientations θ0 to θ10 spreading in the vehicle width direction. The optical system 41 radiates reflected light arriving from different orientations to the light receiving elements corresponding to the orientations. Then, the light receiving element having received the reflected light from the corresponding orientation outputs, by a photoelectric conversion effect, a light reception signal corresponding to the amount of light received.

Additionally, each of the light receiving elements D0 to D10 enables the multiplication factor to be adjusted, and outputs the light reception signal with a voltage value corresponding to the multiplication factor. In other words, the multiplication factor of the light receiving element may correspond to the sensitivity of the light receiving element. The multiplication factor of the light receiving element is determined depending on the bias voltage input to the light receiving element.

The bias control circuit 45 inputs, to each of the light receiving elements D0 to D10, the bias voltage corresponding to the bias voltage signal input by the D/A converter 14 of the control unit 10. Note that in the present embodiment, the D/A converter 14 can input only one bias voltage signal to the bias control circuit 45. Then, the bias control circuit 45 inputs, to all of the light receiving elements D0 to D10, the bias voltage with the same value corresponding to the bias voltage signal. In other words, in the present embodiment, the control unit 10 is configured to set the bias voltages of the light receiving elements D0 to D10 to a uniform value.

However, for example, the control unit 10 may individually set the values of bias voltages of the light receiving elements D0 to D10. Then, in response to an indication from the control unit 10, the bias control circuit 45 may respectively input the individually set bias voltages to the light receiving elements D0 to D10.

Each of the amplification circuits 43 is connected to the corresponding light receiving element to amplify the light reception signal output from the light receiving element. The amplification circuit 43 then outputs the amplified light reception signal to the distance measuring circuit 44.

Based on the light reception signals from the light receiving elements D0 to D10 amplified by the amplification circuit 43, the distance measuring circuit 44 measures the elapsed time from the emission of the pulsed light 100 by the light emitting unit 30 until the reception of reflected light of the pulsed light 100. Then, the distance measuring circuit 44 converts the elapsed time into a distance from the own vehicle to the reflection point, and outputs the calculated distance to the control unit 10.

The monitor circuit 46 is provided to measure the amount of DC light received at each of the light receiving elements D0 to D10. The DC light is light with an intensity varying moderately compared to the pulsed light 100 radiated by the light emitting unit 30, or the like. In other words, the intensity of the DC light varies by a smaller amount per unit time than the intensity of the pulsed light 100 or the like. Note that natural light such as sunlight corresponds to the DC light.

The state of the connection between the monitor circuit 46 and each of the light receiving elements D0 to D10 is controlled by a selection circuit not illustrated. Additionally, the monitor circuit 46 amplifies the light reception signals received from one or more of the light receiving elements D0 to D10 connected via the selection circuit, and outputs, to the A/D converter 13 of the control unit 10, monitor signals corresponding to the amplified light reception signals. Then, based on the voltage values of the monitor signals detected via the A/D converter 13, the control unit 10 measures the amount of light received at each of the light receiving elements D0 to D10.

### 4. Measurement of Distance

The control unit 10 uses the light emitting unit 30 to radiate the pulsed light 100 at periodic timings. On the other hand, the optical system 41 is configured to radiate light arriving from the orientations θ0 to θ10 to the corresponding light receiving elements in sequence, thus guiding the reflected light from the different orientations to the light receiving elements corresponding to the orientations.

Then, the light receiving elements D0 to D10 output, to the distance measuring circuit 44, the light reception signals corresponding to the amounts of light received. On the other hand, the distance measuring circuit 44 detects reception of the reflected light based on the light reception signals, and measures the elapsed time from the emission of the pulsed light 100 until the reception of reflected light of the pulsed light 100. Based on a measurement result, the distance measuring circuit 44 measures the distance from the own vehicle to the reflection point of the pulsed light 100. Then, the control unit 10 acquires the measurement result for the distance from the distance measuring circuit 44, and uses the measurement result to measure the distance between the own vehicle and the object present in front of the own vehicle.

The light reception signals output from the light receiving elements D0 to D10 may contain a noise component resulting from the reception of the DC light described above, or the like. Then, in a case where the light reception signal contains a large noise component, an error is likely to occur in the measurement result for the reflection point.

Thus, at a timing when each of the light receiving elements D0 to D10 receives no reflected light, the control unit 10 measures the voltage value of the monitor signal obtained by amplifying the light reception signal from the light receiving element, and based on a measurement result, measures the amount of DC light received at the light receiving element. In other words, the monitor signal indicates the amount of light received at the light receiving element, and based on the monitor signal, the noise component contained in the light receiving element is detected. Then, the control unit 10 determines any of the light receiving elements to have a large amount of DC light received, and discards the measurement result for the reflection point obtained from the determined light receiving element. Thus, the distance to the object is measured without using any light reception signal containing a large number of noise components.

### 5. Adjustment of Light Receiving Elements

A manufacturing process for the measurement apparatus 1 includes an adjustment process for setting the multiplication factor of each of the light receiving elements D0 to D10 to a target value (hereinafter denoted as T). Note that in the present embodiment, T is 17 by way of example. The multiplication factor is set by an adjustment apparatus 200 irradiating each of the light receiving elements D0 to D10 with reference light 150 (see FIG. 2). The reference light 150 is light with an intensity fixed to a preset level. The reference light 150 corresponds to the above-described DC light and has an intensity maintained at the same level at least while the multiplication factor is set.

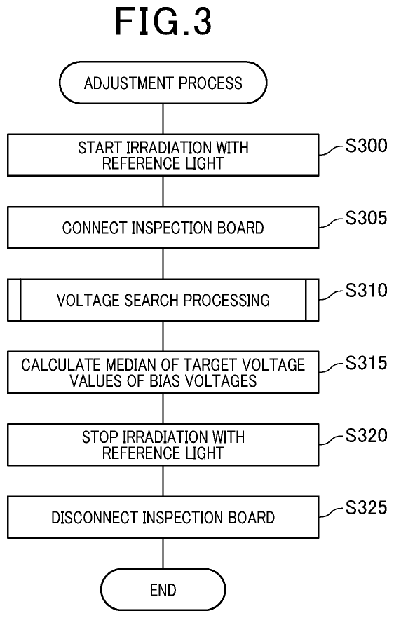

In the present embodiment, by way of example, the adjustment process is executed in a stage prior to assembly of the measurement apparatus 1 is complete. Operations performed in the adjustment process by an operator will be described below in detail using the flowchart in FIG. 3.

### (1) Adjustment Process

In the adjustment process, first, the adjustment apparatus 200 is connected to the control unit 10 of the measurement apparatus 1. The adjustment apparatus 200 includes a reference light source 210 and a driving circuit 220 that drives the reference light source 210. The control unit 10 causes the reference light source 210 via the driving circuit 220 to start radiating the reference light 150 (S300).

Subsequently, an inspection board 250 is connected to a control board in the measurement apparatus 1 equipped with the control unit 10 and the like (S305). Additionally, the components included in the measurement apparatus 1 being assembled are arranged such that the reference light 150 can reach each of the light receiving elements D0 to D10.

Note that the inspection board 250 is used in voltage search processing described below. That is, in the present embodiment, the range of the value of the bias voltage that can be set via the bias control circuit 45 is limited. In other words, a part of the range (hereinafter referred to as the limited range) of the bias voltage that can be set for each of the light receiving elements D0 to D10 fails to be set via the bias control circuit 45. Specifically, in the present embodiment, the range including the value of the bias voltage corresponding to a multiplication factor of 1 is the limited range. However, in the voltage search processing described below, the bias voltage needs to be set to a value within the limited range. In such a case, the bias voltage is set via the inspection board 250. In other words, in a case where the bias voltage is set to a value within the limited range, the inspection board 250 directly inputs the bias voltage to each of the light receiving elements D0 to D10, according to instructions from the control unit 10. Of source, with no limited range provided, the inspection board 250 need not be connected.

Subsequently in S310, the control unit 10 of the measurement apparatus 1 starts, for each of the light receiving elements D0 to D10, the voltage search processing for searching for the value of the bias voltage (hereinafter referred to as the target voltage value) corresponding to a multiplication factor of T. Specifically, for example, the control unit 10 may start the voltage search processing when connection of the inspection board 250 is detected, or start the voltage search processing when a start operation performed by the operator or the like is detected.

Subsequently in S315, the control unit 10 stores the median of the target voltage values of the light receiving elements D0 to D10 searched by the voltage search processing in the memory 12 as a setting value for the bias voltage. Alternatively, the control unit 10 may use, for example, the average of the target voltage values of the light receiving elements D0 to D10 as a setting value for the bias voltage. Subsequently, the irradiation with the reference light 150 is stopped (S320), and the control board in the measurement apparatus 1 and the inspection board 250 are disconnected from each other (S325), ending the adjustment process.

Subsequently, when the measurement apparatus 1 starts measurement, the control unit 10 of the measurement apparatus 1 reads the setting value of the bias voltage from the memory 12. Then, the control unit 10 outputs the bias voltage signal corresponding to the setting value, to the bias control circuit 45 via the D/A converter 14. Thus, the bias voltages of the light receiving elements D0 to D10 are set to the setting value via the bias control circuit 45.

### (2) Voltage Search Processing

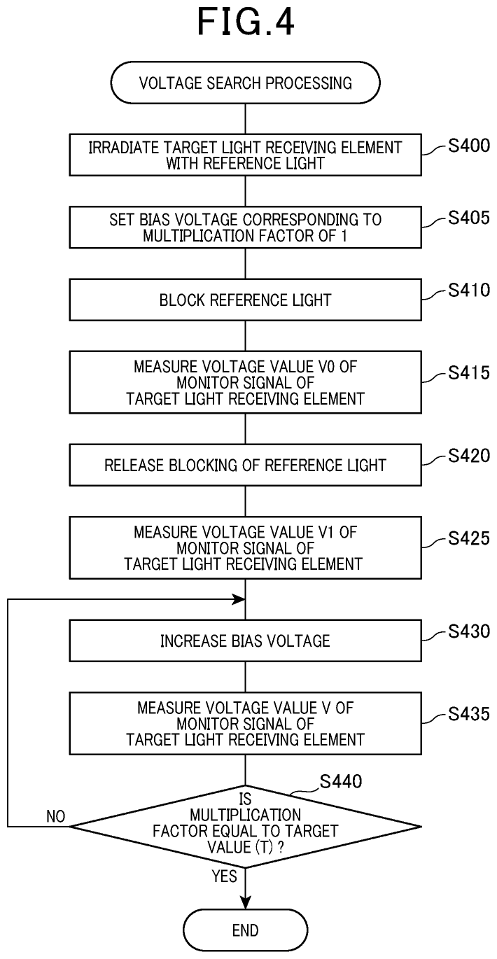

Now, the voltage search processing executed in S310 of the adjustment process will be described using a flowchart in FIG. 4. Note that as described above, the voltage search processing is executed in association with each of the light receiving elements D0 to D10 as described above. Thus, the number of times that the voltage search processing is executed corresponds to the number of the light receiving elements provided in the measurement apparatus 1.

In S400, the control unit 10 rotationally displaces the optical path changing unit in the optical system 41 such that the light receiving element to be subjected to the voltage search processing (hereinafter referred to as the target light receiving element) is irradiated with the reference light 150. The processing then transitions to S405.

In S405, the control unit 10 sets the bias voltages of the target light receiving element to a preset reference value via the inspection board 250 such that the target light receiving element has a multiplication factor of 1. Note that in a case where no limited range is set for the value of the bias voltage, the bias voltage is set via the bias control circuit 45.

Subsequently in S410, in response to an indication from the control unit 10, the adjustment facility 200 closes a shutter provided in the reference light source 210 and not illustrated to block the irradiation of the target light receiving elements with the reference light 150. Then, the control unit 10 measures the voltage value of the monitor signal (hereinafter referred to as denoted as V0) obtained by amplifying the light reception signal from the target light receiving element via the monitor circuit 46 (S415).

In S420, in response to an indication from the control unit 10, the adjustment facility 200 opens the shutter to irradiate the target light receiving element with the reference light 150. Then, the control unit 10 measures the voltage value of the monitor signal (hereinafter referred to as denoted as V1) obtained by amplifying the light reception signal from the target light receiving element irradiated with the reference light (S425).

Then, in S430 to S440, the control unit 10 searches for the value of the bias voltage corresponding to the target light receiving element having a multiplication factor of T. Specifically, in a case where the target light receiving element has a multiplication factor of T, the voltage value of the monitor signal (hereinafter denoted as Vt) obtained by amplifying the light reception signal from the target light receiving element satisfies the relationship (V1−V0)×α=Vt−V0. Note that a is a coefficient set depending on T. While monitoring the voltage value of the monitor signal (hereinafter denoted as V), the control unit 10 searches for the value of the bias voltage corresponding to V=Vt by gradually increasing the value of the bias voltage from the reference value via the bias control circuit 45 or the inspection board 250.

In other words, in S430, the control unit 10 increases the bias voltage by a predetermined value, and then measures the V (S435). Subsequently in S440, the control unit 10 determines whether V−V0 is equal to or greater than (V1−V0)×α to determine whether the current value of the bias voltage corresponds to the target light receiving element having a multiplication factor of T. Then, in a case where the determination result is affirmative (S440: Yes), the control unit 10 saves the current value of the bias voltage as the target voltage value of the target light receiving element. In a case where the determination result is negative (S440: No), the control unit 10 ends the present processing.

### 6. Effects

The present embodiment produces the following effects.

(1) According to the above-described embodiment, when the multiplication factor of each of the light receiving elements D0 to D10 is adjusted, each of the light receiving elements D0 to D10 is irradiated with the reference light 150 with an intensity fixed to the preset level. Thus, the timing when each of the light receiving elements D0 to D10 is irradiated with the reference light 150 can be easily synchronized with the timing when the monitor signal is monitored. Consequently, each of the light receiving elements D0 to D10 can be more simply adjusted.

(2) Additionally, the monitor circuit 46 is used to detect a noise component contained in the light reception signal from each of the light receiving elements D0 to D10. Thus, each of the light receiving elements D0 to D10 can be adjusted while the configuration provided in the measurement apparatus 1 for measuring the distance to an object is effectively utilized.

(3) Additionally, the measurement apparatus 1 is provided with the plurality of light receiving elements D0 to D10. Thus, the distance to the object can be accurately measured.

### 7. Other Embodiments

The embodiment of the present disclosure has been described. However, the present disclosure is not limited to the above-described embodiment, and variations may be made to the embodiment.

(1) In the above-described embodiment, in the manufacturing process for the measurement apparatus 1, the multiplication factor of each of the light receiving elements D0 to D10 is adjusted. However, the multiplication factor may be adjusted after the manufacture of the measurement apparatus 1 by irradiating each of the light receiving elements D0 to D10 with the reference light 150 as is the case with the above-described embodiment. Specifically, for example, a user of the measurement apparatus 1 or a provider maintaining the measurement apparatus 1 may adjust the multiplication factor by causing the measurement apparatus 1 to execute the above-described voltage search processing while using the reference light 150.

(2) In the above-described embodiment, the monitor circuit 46 is used to detect a noise component contained in the light reception signal from each of the light receiving elements D0 to D10. However, the monitor circuit 46 may be configured as a circuit dedicated to adjustment of the multiplication factor of each of the light receiving elements D0 to D10.

(3) A plurality of functions provided in one component according to the above-described embodiment may be implemented by a plurality of components, or one function provided in one component may be implemented by a plurality of components. Additionally, a plurality of functions provided in a plurality of components may be implemented by one component, or one function achieved by a plurality of components may be implemented by one component. In addition, a part of the configuration of the above-described embodiment may be omitted.

Additionally, at least a part of the configuration of the above-described embodiment may be added to or replaced with another configuration of the above-described embodiment.

### [8. Correspondence Relationship of Language]

In the measurement apparatus 1, the distance measuring circuit 44 corresponds to the measurement unit, the control unit 10 corresponds to the detection unit, and S400 to S440 of the voltage search processing correspond to the adjustment unit.

1. A measurement apparatus mounted to a vehicle, the measurement apparatus comprising:
a light emitting unit configured to radiate pulsed light;
at least one light receiving element configured to output a light reception signal corresponding to an amount of light received at a preset sensitivity, and to receive reflected light of the pulsed light radiated by the light emitting unit;
a measurement unit configured to measure an object based on the light reception signal output from the at least one light receiving element having received the reflected light;
a monitor circuit configured to generate a monitor signal indicating the amount of light received by the at least one light receiving element based on the light reception signal output from the at least one light receiving element; and
an adjustment unit configured to adjust the sensitivity of the at least one light receiving element, based on the monitor signal generated by the monitor circuit based on the light reception signal from the at least one light receiving element having received reference light with an intensity fixed to a preset level.

2. The measurement apparatus according to claim 1, further comprising:
a detection unit configured to detect, based on the monitor signal, a noise component contained in the light reception signal.

3. The measurement apparatus according to claim 1, wherein
the at least one light receiving element includes a plurality of light receiving elements.

4. The measurement apparatus according to claim 2, wherein
the at least one light receiving element includes a plurality of light receiving elements.
